(19) United States
(12) Patent Application Publication
(10) Pub. No.: US 2024/0248491 A1
(43) Pub. Date: Jul. 25, 2024

(54) ROBOTICS DEVICE CONTROL SIGNALS BASED ON MOVEMENT DATA

(71) Applicants: DISNEY ENTERPRISES, INC., Burbank, CA (US); ETH Zürich, Zürich (CH)

(72) Inventors: Moritz Niklaus Bächer, Zürich (CH); Farbod Farshidian, Zürich (CH); Marco Hutter, Niederwil (CH); Ruben Jelle Grandia, Opfikon (CH); Lars Espen Knoop, Birmensdorf (CH); Christian Gabriel Schumacher, Aarau (CH)

(21) Appl. No.: 18/394,287

(22) Filed: Dec. 22, 2023

Related U.S. Application Data
(60) Provisional application No. 63/440,750, filed on Jan. 24, 2023.

(51) Int. Cl. G05D 1/646; G05D 1/243

(52) U.S. Cl. CPC G05D 1/646; G05D 1/243

(57) ABSTRACT

Techniques for generating robotics control signals are disclosed. Movement data is received for a desired motion for a robotics device, which can include animation, motion capture, sensor data, or movement of a different robotics device. Robotics device data is received, including control data and reference points corresponding to locations on the robotics device. A correlation is determined between movement data points in the movement data and the reference points. Using the control data, a control signal is determined based on the desired motion. The control signal is based on a distance between at least one movement data point and at least one reference point. The disclosed technology can retarget motions onto under-actuated systems and without regard to differences in degrees of freedom, mass distributions, and proportions of robotics devices.

### CROSS REFERENCE TO RELATED APPLICATION

This application claims priority and benefit of the Applicant's U.S. Provisional Application No. 63/440,750, filed on Jan. 24, 2023, titled “Differentiable Optimal Control for Retargeting Motions Onto Legged Robots,” which is incorporated herein by reference in its entirety for all purposes.

### FIELD

Described embodiments relate generally to determining and/or generating control signals for robotics devices.

### BACKGROUND

Robotic devices typically include actuators that are configured to move various components (e.g., arms, legs, etc.) in different manners. Such actuators can be controlled by devices, such as controllers, that determine how and when to actuate movement. The controllers can be time-intensive to program accurately, such that updating desired movement patterns across different robotic devices, e.g., to scale to different proportional devices or types of devices, can take many man hours and require multiple iterations of testing and updating the controller signals.

### SUMMARY

The following Summary is for illustrative purposes only and does not limit the scope of the technology disclosed in this document.

In an embodiment, a computer-implemented method of determining control signals for robotics devices is disclosed. Movement data is received corresponding to a desired motion for a robotics device. The robotics device can be a legged robotics device, a simulation of a robotics device, or both. In some implementations, the movement data comprises animation data, motion capture data, or sensor data. In some implementations, the movement data corresponds to a movement of a different robotics device. Robotics device data is received for the robotics device, the robotics device data including control data and a set of reference points corresponding to a set of locations on the robotics device. A correlation is determined between a set of movement data points in the movement data and the set of reference points. At least one control signal is determined using the control data to change a state of the robotics device based on the desired motion for the robotics device. The at least one control signal is determined based on a distance between at least one movement data point in the set of movement data points and at least one reference point in the set of reference points.

In some implementations, the at least one control signal is determined based on minimizing the distance between the at least one movement data point and the at least one reference point.

In some implementations, the method includes determining a trajectory associated with the at least one movement data point, the at least one control signal being based on the trajectory.

In some implementations, the set of movement data points, the set of reference points, or both are identified by a user.

In some implementations, a set of weights is received from a user corresponding to the set of movement data points, the at least one control signal being determined at least in part based on the set of weights.

In some implementations, the robotics device data comprises dimensions of the robotics device, a weight of one or more portions of the robotics device, a set of possible states of the robotics device, degrees of freedom of at least one component of the robotics device, or combinations thereof.

In some implementations, the method includes modifying the at least one control signal in response to a changed environmental condition.

In some implementations, determining the at least one control signal comprises determining error values associated with distances between the set of movement data points and the set of reference points.

In some implementations, the at least one control signal is determined in real time.

In some implementations, the state of the robotics device comprises a position and an orientation of the at least one reference point at a time point. In some implementations, the state of the robotics device relates to a linear movement or an angular movement of at least one component of the robotics device.

In another embodiment, a computer-implemented method of retargeting one or more movements onto a robotics device is disclosed. Movement data is received corresponding to a target motion for a robotics device. The robotics device can be a legged robotics device, a simulation of a robotics device, or both. The movement data can comprise animation data, motion capture data, or sensor data. Characteristics of the robotics device are determined, the characteristics comprising control data, a set of reference points corresponding to a set of locations on the robotics device, and dimensions of the robotics device. A mapping is determined between the target motion for the robotics device and a trajectory for the set of reference points, the mapping based on the control data and the dimensions of the robotics device. The mapping is to minimize a distance between the set of reference points and a set of movement data points corresponding to the target motion. A control signal is generated based on the mapping.

In some implementations, the method further includes determining a trajectory associated with at least one movement data point of the set of movement data points, the control signal being based on the trajectory.

In some implementations, the set of movement data points, the set of reference points, or both are identified by a user.

In some implementations, the method further includes receiving a set of weights from a user corresponding to the set of movement data points, the control signal being determined at least in part based on the set of weights.

In yet another embodiment, a computer-implemented method of generating a modified control signal for a robotics device is disclosed. A desired motion sequence is received for a first robotics device having a first set of characteristics. The first set of characteristics comprises dimensions of the first robotics device. A correlation is determined between a first set of reference points corresponding to one or more locations on the first robotics device. With a second set of reference points corresponding to one or more locations on a second robotics device, the second robotics device has a second set of characteristics different from the first set of characteristics. A modified control signal is generated based on the correlation, the second set of characteristics, and the first set of characteristics. The modified control signal is to control the second robotics device to generate the desired motion sequence.

In some implementations, operations of one or more methods disclosed herein can be combined.

In another embodiment, a system is disclosed including one or more processors and one or more memories carrying instructions configured to cause the one or more processors to perform the foregoing methods.

In yet another embodiment, a computer-readable medium is disclosed carrying instructions configured to cause one or more computing systems or one or more processors to perform the foregoing methods.

### BRIEF DESCRIPTION OF THE DRAWINGS

FIG. 1 is a block diagram illustrating a system flow for robotics device control.

FIG. 2 is a block diagram illustrating a computing device for implementing a robotics device control system.

FIG. 3 is a flow diagram illustrating a process performed using a robotics device control system.

FIG. 4 is a display diagram illustrating operations performed using a robotics device control system.

### DETAILED DESCRIPTION

Existing systems for controlling robotics devices may be based on movement patterns, which may be defined by control signals. For example, robotics devices can be preprogrammed, partially or fully autonomous, or remotely controlled to perform various operations, which can be based on ranges (e.g., degrees of freedom) for movement of components of the robotics devices. Existing systems may be unable to be quickly and efficiently controlled to perform a target motion, such as a movement based on a reference animation, motion capture data, or sensor data. As used herein, a target motion can refer to a desired or input motion or movement that a user wishes for a robotics device to perform. For example, existing systems may be unable to receive an artistic or expressive input provided by an animator, a motion capture input, or a sensor input for a target movement and generate a closest approximation of the artistic input for controlling a robotics device. Additionally, such systems cannot retarget expressive motions in real time, such as to make changes to animation or motion capture data (e.g., of an animal or actor) or provide control signals for a desired motion to other types of devices, such as those with varying proportions or other different characteristics (e.g., different dimensions, mass distribution, degrees of freedom, etc.). Instead, such systems rely on manual programming and trial and error, which is inefficient and time-consuming, and which may not be able to adequately mirror target motions.

While some robotic systems may use machine learning to generate control signals, users of such systems may have limited or indirect control of the resulting motion. While some systems may have an ability to interface either with artistic or captured inputs, they require a robotics device performing a retargeted motion having similar proportions, is bolted to the ground, or including preprocessed data formatted with tedious manual pre-processing.

Various embodiments include a method to generate control signals for robotics devices (“system” or “robotics device control system”) based on movement data, which can be motion capture data, animation data, sensor data, and/or one or more movements performed by a different robot. The movement data for a target motion is used and retargeted to generate a control signal for a specific robotics device, such that the device can perform movements that most closely mimic those of the target motion, but be based on the original control signals for another robotics device that may be similar, but have different characteristics than the device being programmed. Retargeting is based on correlations between one or more movement data points in the movement data and one or more reference data points associated with a robotics device (i.e., the device to be programmed). For example, various embodiments can be used to minimize, optimize, and/or configure distances between the one or more movement data points and corresponding reference data points, allowing a faster transformation of control signals between different robotics devices. Specifically, utilizing select points (e.g., tracked movement points), these points can be used to scale a target motion up or down or in other dimensions depending on the differences between the points of the original robotics device and that of the new or retargeted robotic device.

In some instances, differential optimal control is used to facilitate transfer of rich motions, such as motions of animals or animations, onto robotics devices. Additionally, a balance of kinematic and dynamic constraints with retargeting objectives can be used, such that robotics devices can perform retargeted motions while also recovering from external disturbances. Moreover, the disclosed technology can be applied using open-loop control strategies, closed-loop control strategies, or both.

Embodiments can perform retargeting of motions onto under-actuated systems (e.g., robotics devices with fewer actuators than degrees of freedom), such as freely-walking robots. Additionally, embodiments can perform retargeting across robotics devices or motion sources that may have widely varying characteristics, such as proportions, mass distributions, degrees of freedom, and so forth. For example, the disclosed technology can retarget a motion of an animal or other biological system onto a robotics device, which may have significantly fewer degrees of freedom, and which may have different proportions or other characteristics as compared to the source of the target motion.

Advantages of the disclosed technology include, without limitation, more efficiently generating control signals for a robotics device to perform (e.g., mimic, simulate, mirror) target motions, such as movements provided in an animation, using motion capture, using sensors, or using control signals for a different robot. Additionally, embodiments enable retargeting to perform a closest approximation of a target movement while also ensuring that the closest approximation is within an acceptable range, such as to ensure that a robotics device remains upright or does not otherwise malfunction. In some implementations, the operations can be performed in real time, without the use of artificial intelligence (AI)/machine learning (ML), and in response to one or more environmental conditions. By not relying on AI or ML techniques, the present disclosure enables better and more accurate control of the robotic device, which is preferable for immersive or entertainment uses as artists can more accurately replicate a desired motion.

The real-time nature of embodiments of the disclosed technology allows a robotics devices to retarget movements even when one or more unexpected conditions are encountered, such as uneven ground, a collision or other disturbance, or the like. Additionally, control signals can be generated for retargeted motions for robotics devices with widely varying characteristics, such as proportions or dimensions, mass/mass distributions, degrees of freedom, control systems, and so forth.

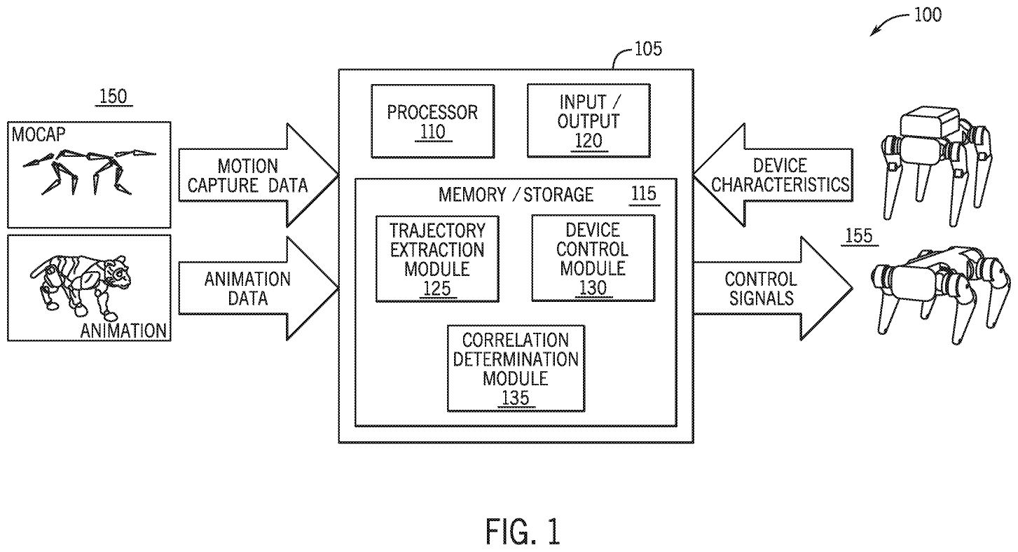

FIG. 1 is a block diagram illustrating a system flow 100 for robotics device control. The system flow 100 can be performed using the system 105, one or more inputs 150 specifying target motions, and one or more robotics devices 155 (e.g., physical or simulated robots) controlled using the system 105. The robotics devices 155 can include a controller, which can include a processor for executing instructions, such as commands (e.g., control signals) provided by the system 105. For example, the system 105 can provide one or more control signals for a command to be executed by the robotics devices 155 based on the one or more inputs 150 to simulate/mimic/retarget one or more target motions in the inputs 150.

The system 105 comprises at least one processor 110, which can be a central processing unit (CPU) and/or one or more hardware or virtual processing units or portions thereof (e.g., one or more processor cores). The at least one processor 110 can be used to perform calculations and/or execute instructions to perform operations of the system 105. The system 105 further comprises one or more input/output components 120. The input/output components 120 can include, for example, a display to provide one or more interfaces provided by the system 105, to display data, to display graphical representations of robotics devices 155, and/or to receive one or more inputs for the system 105. Additionally or alternatively, input/output components 120 can include various components for receiving inputs, such as a mouse, a keyboard, a touchscreen, a biometric sensor, a wearable device, a device for receiving gesture-based or voice inputs, and so forth. In an example implementation, the input/output components 120 are used to provide one or more interfaces for configuring control signals for robotics devices 155 and/or providing the inputs 150 (e.g., typed inputs provided using a keyboard, selections of hardware and/or software buttons or icons, and/or voice or gesture commands), and so forth.

The system 105 further comprises one or more memory and/or storage components 115, which can store and/or access modules of the system 105, the modules including at least a trajectory extraction module 125, a device control module 130, and/or a correlation determination module 135. The memory and/or storage components 115 can include, for example, a hardware and/or virtual memory, and the memory and/or storage components 115 can include non-transitory computer-readable media carrying instructions to perform operations of the system 105 described herein.

The trajectory extraction module 125 receives and processes data in the inputs 150 to determine one or more trajectories. For example, the trajectory extraction module 125 can receive movement data representing a target motion to be performed by a robotics device. The movement data can comprise motion capture data, animation data, sensor data, and/or a motion associated with a robotics device (e.g., a device different from the device that will be performing the motion). The movement data can comprise a set of movement data points (e.g., one or more movement data points). A movement data point can correspond to a specific location on an animal, an actor, an animated character, a different robotics device, or the like. In some implementations, movement data points can be linked or grouped. In some implementations, the movement data received by the trajectory extraction module can comprise one or more weights, such as weights associated with movement data points. The weights can indicate an importance or ranking of a portion of the movement data, such as more important or less important movement data. For example, a highly-weighted movement data point (e.g., 7-10 on a scale of 1-10) can indicate that a trajectory or movement of that data point should be prioritized over a trajectory or movement of a comparatively lower-weighted movement data point (e.g., 1-3 on a scale of 1-10) when control signals are generated to retarget a motion in the movement data. Weights can be received, for example, from a user and/or via a user interface. The trajectory extraction module 125 identifies, determines, and/or generates one or more trajectories associated with the movement data, such as changes in position of one or more movement data points over time. Trajectories can include, for example, position or state information at different time points, velocity, acceleration, force, or the like.

In an example implementation, movement data is received, specifying a target motion captured using motion capture technologies and/or using other sensors. Movement data points are identified in the received movement data, and weights are associated with the movement data points. The weights can specify, for example, whether head movements should be prioritized over body movements, whether facial movements should be prioritized over limb movements, or the like. Using the movement data, the points, and the weights, a trajectory can be defined characterizing the target motion, which can be used to determine control signals for a retargeted motion.

The device control module 130 provides and/or determines control signals comprising commands to be executed by the robotics devices 155. Control signals provided by the device control module 130 are communicated to the robotics devices 155 via the input/output components 120 using a wired and/or wireless connection, such as using one or more cables, using a WiFi or Bluetooth connection, using radio frequency (RF) signals, or the like. In some implementations, the device control module 130 determines one or more characteristics of robotics devices 155, such as dimensions, mass distributions, proportions, degrees of freedom, components, available commands or control signals, and so forth. For example, the device control module 130 can receive and/or identify robotics device data, which can include control data and/or a set of reference points corresponding to locations on a robotics device 155. Based on the control data and one or more correlations determined by the correlation determination module 135, the device control module 130 can determine and/or generate one or more control signals to change a state of a robotics device 155 based on a desired and/or target motion specified in the inputs 150.

The correlation determination module 135 determines correlations between movement data received via the trajectory extraction module 125 and robotics device data received via the device control module 130. For example, the correlation determination module 135 determines a correlation between a set of movement data points in the movement data and a set of reference points in the robotics device data, which can be used to generate control signals for a robotics device. Correlations can comprise or be used to determine, for example, distances between movement data points and reference data points and/or error values based on these distances. In other words, correlations can be used to determine how closely movements of reference data points of a robotics device match corresponding movements of movement data points to determine an optimal set of control signals for a robotics device to simulate a target motion. In some implementations, the correlation can be used to minimize a distance between one or more movement data points and one or more corresponding reference data points (e.g., over a trajectory and/or across one or more time points).

Operations performed by the system 105 (e.g., using modules 125, 130, and 135) can be for generating control signals to cause the robotics devices 155 to perform one or more dynamic motions specified in the inputs 150. To determine appropriate control signals, the system 105 can use control problems of the form:

$$\begin{matrix}min \\ x ( t ) , u ( t )\end{matrix} {\int }_{{t}_{s}}^{{t}_{e}} f ( x ( t ) , u ( t ) ; p ) dt + F ( x ( {t}_{e} ) ; p ) \qquad ( 1 )$$

s.t. robot in dynamic equilibrium for all t,
   where x(t) is a time-varying state of the robot (e.g., based on control signals provided by the device control module 130) and u(t) the corresponding control trajectory, are solved for a fixed time horizon [tₛ, tₑ]. The objective f measures the difference to the target motion (e.g., specified in inputs 150 and/or extracted via the trajectory extraction module 125), parameterized with parameters p that provide control of the retargeting result. The terminal objective, F, accounts for effects beyond the finite horizon. For example, the terminal objective can be used to determine an end state from which a robotics device can transition into standing (e.g., from a seated position).

For example, using a motion capture system and/or other data captured using one or more sensors, the disclosed technology can track the motion of a set of points on an animal's body. Similarly, the disclosed technology can extract target trajectories of points of interest on an artist-specified input. To retarget an extracted motion onto a robot, the disclosed technology can define reference points on the robot, then guide their motion using the extracted target trajectories. Measuring the differences between simulated and target states with per-point objectives, the disclosed technology can configure (e.g., minimize) a weighted sum of differences by solving for optimal state and control trajectories, x(t) and u(f).

A legged robot may have a relatively small number of degrees of freedom (e.g., two or more limbs that may move within one or more dimensions according to a preset angular and/or linear range), and the motion of its components may be tightly coupled. Accordingly, a target motion for a legged robot may have more objectives than degrees of freedom in retargeting tasks. Due to the coupling, an increase in parameters can have a counter-intuitive, non-local effect.

To address this problem in a way that is indifferent to differences in device characteristics (e.g., proportions, mass distribution, number of degrees of freedom), the disclosed technology can parameterize the non-uniform scaling of target trajectories, and/or the reference location and orientation of points of interest on the components of the robot.

The disclosed technology can then make the optimal control problem differentiable with respect to parameters, finding values for p so that the sum of weighted objectives is acceptable (e.g., optimal and/or as small as possible). The disclosed technology can formulate an optimal retargeting as a bi-level optimization problem:

$$\begin{matrix}min \\ p\end{matrix} {\int }_{{t}_{s}}^{{t}_{e}} g ( \underline{x} ( t , p ) , \underline{u} ( t , p ) ; p ) dt + G ( \underline{x} ( {t}_{e} , p ) ; p ) \qquad ( 2 )$$

s.t. parameters fulfill a set of requirements,
   resulting in small error values in g that are set to the weighted sum of retargeting objectives f and additional regularization terms where applicable.

Because the optimal state and control trajectories, x(t) and u(t), change when adjustments are made to the parameters or weights, they implicitly depend on p.

In order to be responsive to external disturbances, the disclosed techniques are executed at real-time rates (e.g., in seconds or fractions of a second) and/or continuously to determine appropriate control signals while a robotics device is performing one or more movements. Accordingly, a layered set of problems (e.g., according to the equations disclosed herein) can be solved at short time horizons (e.g., seconds or less) and simulation representations at one or more layers (e.g., depending on closeness to hardware of a robotics device). For example, the disclosed technology can be applied at a model-predictive control (MPC) layer having a longest time horizon in a control stack of a robotics device. In various embodiments, the predictive control layer can be used to provide an approximate model of a robotics device, and the model can be used to predict motion of the robotics device over a time horizon (e.g., seconds or less).

Because a fixed and finite time horizon may be assumed, it is common practice to differentiate between an intermediate objective f and a terminal objective F. The terminal objective is added to account for an infinite horizon when solving the control problem for a finite horizon.

To ensure that appropriate (e.g., optimal) state and control trajectories are feasible, the disclosed techniques can constrain these factors to fulfill kinematic and dynamic constraints, \dot{x}=f(x(t),u(t)). By introducing velocity variables, second-order equations that describe the dynamics of a robotics device, can be brought into this standard form. The initial state of the robotics device, x (tₛ)=xₛ, can be estimated using sensors. Because velocities are included in these initial values, the disclosed techniques can solve the control problem from an arbitrary point in time.

In an example implementation, if a foot of a robotics device is in contact with the ground, its velocity must remain zero, and if a foot is in a swing phase, the contact force that acts on the foot cannot take on non-zero values. Conditions like these may be best enforced with additional constraints, g(x(t), u(t))=0.

To ensure that the control problem remains differentiable, the disclosed techniques can assume the foot fall pattern of a robotics device to be constant. Moreover, the disclosed techniques assume that friction cone constraints, which are usually formulated as a set of inequality constraints, are enforced with penalties that are part of the objective f. Additionally or alternatively, the disclosed techniques can record the set of active inequality constraints, and treat them as equality constraints. However, this would mean that the number of constraints would vary over time, and changes to the active set could not be considered.

The continuous-time formulation of the class of control problems that are considered according to the disclosed technology can therefore be represented as:

$$\begin{matrix}min \\ x ( t ) , u ( t )\end{matrix} {\int }_{{t}_{s}}^{{t}_{e}} f ( x ( t ) , u ( t ) ; p ) dt + F ( x ( {t}_{e} ) ; p ) \qquad ( 3 )$$

$$s . t . x ( {t}_{s} ) = {x}_{s} and \dot{x} = f ( x ( t ) , u ( t ) )$$

$$and g ( x ( t ) , u ( t ) ) = 0.$$

Various embodiments may rely on objectives that measure differences in position, orientation, and linear and angular velocity at a dense set of locations, enabling the disclosed technology to determine how to optimally weigh them.

In some instances, a local coordinate frame is defined for one or more rigid components of a robotics device. For articulated body formulations, these frames can be centered at joint locations. For maximal coordinate formulations, it may be desirable to choose the center of mass of components as origins. The disclosed techniques can interface with either representation or different representations.

In an example implementation, a user-selected location r_{rb} and frame A_{rb} that moves with a rigid body of a robotics device is determined, and the retargeting objective can compare a simulated position r and frame A to a target position \hat{r} and target frame Â.

When defining correspondences, a user selects a location, r_{rb}, and orthonormal frame axes, A_{rb}=[aₓ, a_{y}, a_{z}], in local coordinates of a component for every point of interest. To measure differences to a provided target motion, the disclosed techniques can then transform the frame from local to global coordinates:

$$r ( x ( t ) , u ( t ) ; p ) = {Rr}_{rb} + t and A ( x ( t ) , u ( t ) ; p ) = {RA}_{rb} \qquad ( 4 )$$

where the rotation matrix R and the translation vector t depend on the state and control trajectories. The frame origin and its axes are part of the set of parameters p that can be optimized. This is helpful if, for example, two points of interest are guiding the motion of a single rigid component. The disclosed techniques can refine initial reference frames to correct offsets between them.

A first type of retargeting objective according to the disclosed techniques penalizes differences in linear motion between simulated and target positions, r and \hat{r}, and corresponding velocities:

$${‖ r - D \hat{r} ‖}_{{W}_{r}}^{2} + {‖ \dot{r} - D \dot{\hat{r}} ‖}_{{W}_{\dot{r}}}^{2} , \qquad ( 5 )$$

with three scaling factors, D=diag(s_{xy}, s_{xy}, s_{z}), that enable nonuniform scaling of target trajectories and can be included in the set of parameters. The disclosed techniques can define an analogous type of objective for angular motion:

$${‖ A Ξ \hat{A} ‖}_{{W}_{A}}^{2} + {‖ ω - \hat{ω} ‖}_{{W}_{ω}}^{2} . \qquad ( 6 )$$

where [symbol] is the logarithm map operator that measures the difference between the two rotation matrices with a three-dimensional angle-axis vector and ω is the angular velocity of the component that frame A_{rb} is attached to.

The weight matrices, Wᵣ, Wₜ, W_{A}, and W_{ω}, are all three-dimensional diagonal matrices, whose weights can be collected in the weight vector w.

To solve the optimal control problem (Eq. 9), the Hamiltonian is first defined:

$$H ( x , u , λ , v ; p ) = f ( x , u ; p ) + {λ}^{T} f ( x , u ) + {v}^{T} g ( x , u ) ,$$

where λ(t) are costates and v(t) Lagrange multipliers. Pontryagin's Minimum Principle (PMP) can then be applied to derive the two-boundary problem the solution of which comprising optimal state, control, costate and Lagrange multiplier trajectories:

$$[ \begin{matrix}{H}_{x} ( \underline{x} , \underline{u} , \underline{λ} , \underline{v} ; p ) \\ {H}_{u} ( \underline{x} , \underline{u} , \underline{λ} , \underline{v} ; p ) \\ {H}_{λ} ( \underline{x} , \underline{u} , \underline{λ} , \underline{v} ; p ) \\ {H}_{v} ( \underline{x} , \underline{u} , \underline{λ} , \underline{v} ; p )\end{matrix} ] = [ \begin{matrix}- \dot{\underline{λ}} \\ 0 \\ \dot{\underline{x}} \\ 0\end{matrix} ] \qquad ( 7 )$$

with boundary conditions

$$\underline{x} ( {t}_{s} ) = {x}_{s} and \underline{λ} ( {t}_{e} ) = {F}_{x} ( \underline{x} ( {t}_{e} ) ) \qquad ( 8 )$$

This two-point problem cannot be directly solved with a standard technique because the boundary condition at time tₑ depends on the optimal state x which is not known. Moreover, since these equations are generally nonlinear with respect to state and input, the employed methods often resort to an iterative approach where they produce successively better approximations to the solution of these equations. While directly solving this equation for high dimensional nonlinear systems is prohibitively complex, a variant of the dynamic programming approach known as Differential Dynamic Programming (DDP) has proven to be a powerful tool in many practical applications. A continuous-time variant of the DDP equation is derived in the Applicant's U.S. Provisional Application No. 63/440,750, including in equations (13)-(39) described therein and the accompanying disclosure.

To solve the bi-level optimization problem defined in equation (2), analytical gradients can be computed:

$${\int }_{{t}_{s}}^{{t}_{e}} ( {g}_{x}^{T} {x}_{p} ( t ) + {g}_{u}^{T} {u}_{p} ( t ) + {g}_{p}^{T} ) dt + {G}_{x}^{T} {x}_{p} ( {t}_{e} ) + {G}_{p}^{T} , \qquad ( 9 )$$

where the total derivatives of the optimal state and control trajectories, xₚ(t) and uₚ(t) cannot directly be computed using symbolic or automatic differentiation.

The total derivatives of the state and control trajectories with respect to the weight-parameter pair, xₚ(t) and uₚ(t), are the solution of a linear two-boundary problem:

$$[ \begin{matrix}{H}_{xx} & {H}_{xu} & {f}_{x}^{T} & {g}_{x}^{T} \\ {H}_{ux} & {H}_{uu} & {f}_{u}^{T} & {g}_{u}^{T} \\ {f}_{x} & {f}_{u} & 0 & 0 \\ {g}_{x} & {g}_{u} & 0 & 0\end{matrix} ] [ \begin{matrix}{x}_{p} \\ {u}_{p} \\ {λ}_{p} \\ {v}_{p}\end{matrix} ] + [ \begin{matrix}{H}_{xp} \\ {H}_{up} \\ {f}_{p} \\ {g}_{p}\end{matrix} ] = [ \begin{matrix}- {\dot{λ}}_{p} \\ 0 \\ {\dot{x}}_{p} \\ 0\end{matrix} ] \qquad ( 10 )$$

with boundary conditions:

$${x}_{p} ( {t}_{s} ) = 0 and {λ}_{p} ( {t}_{e} ) = {F}_{xx} ( \underline{x} ( {t}_{e} ) ) {x}_{p} ( {t}_{e} ) + {F}_{xp} ( \underline{x} ( {t}_{e} ) ) \qquad ( 11 )$$

that can be derived using small perturbations of optimal trajectories and Taylor expansions of the equations in equation (7).

This two-boundary problem is not in standard form.

The computed gradient described above is utilized in the upper-level optimization of the pipeline to find suitable (e.g., optimal) parameters of the retargeting task. For example, the disclosed technology can employ a projected gradient approach to optimize the problem in equation (2). In an example implementation, a class of optimizations can be determined for which the projection to their feasible set can be computed readily, such as using box constraints or problems with linear equality constants.

If there was no uncertainty in the environment, and the sim-to-real gap in a simulation representation of a robotics device was small, the above nonlinear problem (equation (3)) could be solved for a time horizon that extends over the entire duration of an animation. However, because an accurate representation of the environment is unknown, the robotics device may need to continuously sense its state (e.g., current position, orientation, velocity, and/or acceleration of one or more components), and balance artistic objectives with kinematic and dynamic constraints.

To be able to respond to disturbances, various embodiments can use strict time budgets for a control problem to be solved (e.g., within seconds or less). A first strategy that can be employed is to shorten the time horizon and repeatedly solve instances of equation (3) from an initial state that is estimated from a set of sensors. However, because the time complexity of simulations of a robotics device can be too high, this strategy can be insufficient. Accordingly, in implementations of the disclosed technology, the problem can be split into a hierarchy of sub-problems comprising a Model Predictive Control (MPC) problem, a Whole Body Control (WBC) problem, and a Low-Level Joint Control (LLJC) problem.

A MPC problem can use a simplified model of a robotics device, and the control trajectories can consist of joint velocities and contact forces of the individual legs. Fed with the estimated state of the robot, this nonlinear MPC problem is solved for a short, fixed time horizon (e.g., seconds or less).

In a WBC problem, the output of the MPC, which represents the desired state of the robotics device (e.g., based on inputs 150 of FIG. 1), is then tracked as closely as possible by solving a second control problem that relies on a whole-body simulation model, but restricts the time horizon to the next time step.

A LLJC problem can use a hardware abstraction layer, which takes as input the WBC output and is responsible to track the desired joint positions, velocities, and torques as closely as possible.

Because error that is introduced by the whole body and low-level joint control layers may be small (e.g., less than 10%), an example implementation can focus largely or solely on MPC and make this layer differentiable. On the contrary, embodiments disclosed herein can interface with both open- and closed-loop control strategies, and can be applicable to variations of the above control stack.

In an MPC formulation, the state variables x can be the linear and angular velocity of the base, and the positions of the joints. The control parameters u can be set to the joint velocities, and the contact forces that act from the ground onto the robot at the feet. As the simulation model, centroidal dynamics formulation is used for f.

In an example implementation, an input target motion (e.g., 150 of FIG. 1) starting at the center with the robot's stance feet at zero height can be assumed. Moreover, the gait sequence, i.e., the order and the timing of foot-drops in the motion, can be extracted from the target (e.g., using 125 of FIG. 1). The disclosed techniques can use a simple heuristic that the velocity of a stance foot should be smaller than a fixed threshold. This threshold can be used, for example, to account for the small velocity at stance feet due to either measurement drift or misplacement of the motion capture markers away from an animal's feet. Finally, a user can define pairs of frames from the target motion and a robotics device—that is, a user can select corresponding image frames showing a state of a robotics device (or representation thereof) in input data (e.g., 150 of FIG. 1) and images and/or simulations of a robotics device (e.g., 155 of FIG. 1). These frame pairs define the objective function in the retargeting pipeline described above.

Any number of frame pairs can be used. For example, 13 frame pairs can be identified. One frame in the base of a robotics device can be used to define a linear motion tracking and an angular motion tracking task. For each leg, one frame per link can be defined with only a linear motion tracking task. This will sum up to 14 tracking tasks. For both the linear and angular motion tasks diagonal weight matrices can be defined as Wᵣ=W_{A}=diag[5, 5, 5] and W_{\dot{r}}=W_{ω}=diag[1, 1, 1]. 3D offsets parameterize each frame position on the robotics device in its parent frame. To further regulate the upper-level optimization, the disclosed technology can employ a different scaling for each category of the parameters. For example, 0.04 can be used for all offsets, and for the cost weights the inverse of the initial weight matrices can be used, which makes the normalized initial weight matrices equal to the identity matrix.

The disclosed technology can aim to configure (e.g., optimize) the offset parameters of all 14 tasks. In an example implementation, the upper-level optimization has 42 open parameters that are initialized to zero. The disclosed technology can be used to transfer a target motion across multiple robotics devices, which span a range of sizes, proportions, mass distributions, and/or other characteristics.

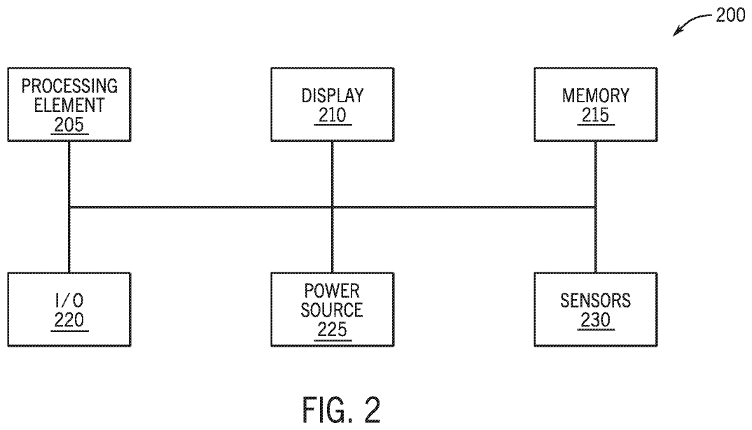

Various operations can be performed by one or more modules of the system 105. In some implementations, more or fewer modules or components can be included in the system 105. In some implementations, the system 105 can be provided via a computing system (e.g., computing device 200 of FIG. 2) and/or a server computer (e.g., to be accessed via one or more networks, such as the Internet). In some implementations, at least a portion of the system 105 resides on the server, and/or at least a portion of the system 105 resides on a user device. In some implementations, at least a portion of the system 105 can reside in the one or more robotics devices 155.

FIG. 2 is a block diagram illustrating a computing device 200 for implementing a robotics device control system (e.g., system 105). For example, at least a portion of the computing device 200 can comprise the system 105, or at least a portion of the system 105 can comprise the computing device 200.

The computing device 200 includes one or more processing elements 205, displays 210, memory 215, an input/output interface 220, power sources 225, and/or one or more sensors 230, each of which may be in communication either directly or indirectly.

The processing element 205 can be any type of electronic device and/or processor (e.g., processor 110) capable of processing, receiving, and/or transmitting instructions. For example, the processing element 205 can be a microprocessor or microcontroller. Additionally, it should be noted that select components of the system may be controlled by a first processor and other components may be controlled by a second processor, where the first and second processors may or may not be in communication with each other. The device 200 may use one or more processing elements 205 and/or may utilize processing elements included in other components. For example, the device 200 implementing the system 105 can use the processor 110 and/or a different processor residing on one or more robotics devices 155.

The display 210 provides visual output to a user and optionally may receive user input (e.g., through a touch screen interface). The display 210 may be substantially any type of electronic display, including a liquid crystal display, organic liquid crystal display, and so on. The type and arrangement of the display depends on the desired visual information to be transmitted (e.g., can be incorporated into a wearable item such as glasses, or may be a television or large display, or a screen on a mobile device).

The memory 215 (e.g., memory/storage 115) stores data used by the device 200 to store instructions for the processing element 205, as well as store data for the robotics device control system, such as robotics device data, control signals, movement data, trajectories, variable values, and so forth. The memory 215 may be, for example, magneto-optical storage, read only memory, random access memory, erasable programmable memory, flash memory, or a combination of one or more types of memory components. The memory 215 can include, for example, one or more non-transitory computer-readable media carrying instructions configured to cause the processing element 205 and/or the device 200 or other components of the system to perform operations described herein.

The I/O interface 220 provides communication to and from the various devices within the device 200 and components of the computing resources to one another. The I/O interface 220 can include one or more input buttons, a communication interface, such as WiFi, Ethernet, or the like, as well as other communication components, such as universal serial bus (USB) cables, or the like. In some implementations, the I/O interface 220 can be configured to receive voice inputs and/or gesture inputs.

The power source 225 provides power to the various computing resources and/or devices. The robotics device control system may include one or more power sources, and the types of power source may vary depending on the component receiving power. The power source 225 may include one or more batteries, wall outlet, cable cords (e.g., USB cord), or the like. In some implementations, a device 200 implementing the system 105 can be coupled to a power source 225 residing on one or more robotics devices 155.

The sensors 230 may include sensors incorporated into the robotics device control system. The sensors 230 are used to provide input to the computing resources that can be used to generate and/or modify control signals. For example, the sensors 230 can include one or more cameras or other image capture devices for capturing images and/or measurement data. Additionally or alternatively, the sensors 230 can use other technologies, such as computer vision, light detection and ranging (LIDAR), laser, radar, and so forth. The sensors 230 can be used to determine one or more states of a robotics device, which can be used to compare the state to one or more intended states represented in movement data. In some implementations, sensors 230 are used to capture movement data, such as data regarding movement of a different robotics device, an animal, or an actor, and the captured movement data can be used to retarget a movement onto a robotics device.

Components of the device 200 are illustrated only as examples, and illustrated components can be removed from and/or added to the device 200 without deviating from the teachings of the present disclosure. In some implementations, components of the device 200 can be included in multiple devices, such as a user device and a robotics device (e.g., 155 of FIG. 1). For example, sensors 230 can be included in a robotics device and/or in a user device implementing the system 105.

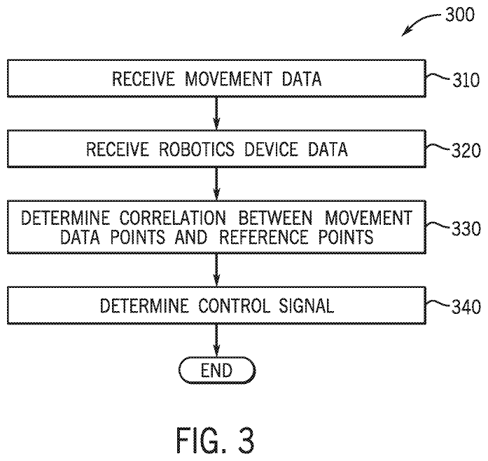

FIG. 3 is a flow diagram illustrating a process 300 performed using a robotics device control system (e.g., system 105). The process 300 can be performed to generate control signals for a robotics device (e.g., 155 of FIG. 1).

At block 310, movement data is received for a desired and/or target motion to be performed by a robotics device. For example, the movement data can correspond to one or more time-varying states (e.g., positions and/or orientations) associated with a robotics device and/or portions thereof. In some implementations, the movement data comprises a desired motion sequence, such as a set of time-varying states for a first robotics device to be translated/retargeted to a second robotics device that is different from the first robotics device.

The movement data can specify positions and/or orientations of one or more components of a robotics device at different times. A robotics device can be, for example, a legged robot and/or a simulation of a robotics device. Examples of movement data can include data specifying running, walking, other limb movement, head movement, tail wagging/movement, changes in facial expression, jumping, rolling, and so forth, which can be performed by a legged robot or other under-actuated robotics device. Although examples are described herein related to legged robots, other kinds of robots and/or robotics devices can be used, such as drones, wheeled devices, devices moving on tracks, ball-shaped/rolling devices, and so forth. Additionally or alternatively, movement data can relate to coordinated movement of multiple robotics devices.

As described herein, the movement data received at block 310 can comprise and/or represent artistic inputs, such as animated movements and/or motion capture movements that a user would like to be performed by a robotics device. In some implementations, the movement data can comprise sensor data captured in relation to one or more movements of an actor, an animal, a different robotics device, or the like. But specified movements may or may not be achievable by a robotics device, for example, due to physical limitations of the robotics device, such as dimensions, mass distribution, degrees of freedom, available control signals, and the like. Accordingly, the process 300 is provided for the robotics device to approximate movements specified in the movement data, while also remaining within acceptable limits and/or specifications for a robotics device, such as simulating target movements while also ensuring that a robotics device will not fall over or otherwise malfunction.

In some implementations, the movement data received at block 310 comprises one or more movements and/or states of a different robot, such as for translating/retargeting movements of a first robot to a second robot, which may have different dimensions, different mass distributions, different degrees of freedom, different control systems, different components, and/or other characteristics.

In some implementations, the movement data received at block 310 comprises one or more movement data points. For example, movement data can be motion capture data, sensor data, and/or animation data indicating positions and/or orientations of one or more points at different times, which are used to plan the movements of a robotics device. In some implementations, the movement data points can be associated with corresponding weights indicating a preference and/or priority for determining the movements of the robotics device. For example, the weights can specify that facial movements of a robot should be prioritized before tail movements, or that body movements should be prioritized before leg movements, or the like. In some implementations, movement data points and/or associated weights or other characteristics can be provided by a user. The movement data can be provided in various formats, such as animation files, video, images, three-dimensional models, drawings, sensor outputs, or the like.

At block 320, robotics device data is received and/or accessed for the robotics device. The robotics device data can comprise control data, such as available control signals for controlling the robotics device, positions and/or states of the robotics device, components of the robotics device, specifications for the robotics device, degrees of freedom of one or more components of the robotics device, dimensions and/or mass distribution of one or more components or portions of the robotics device, and so forth. Additionally or alternatively, the robotics device data comprises a set of reference data points corresponding to respective locations (e.g., physical locations) on the robotics device. The robotics device data can be used to determine, identify, and/or generate one or more characteristics of the robotics device, such as degrees of freedom, achievable states and/or movements, mass distribution, center of mass/gravity, and so forth.

In some implementations, at least a portion of the robotics device data can be received from a user. For example, a user can specify locations of the set of reference data points.

At block 330, a correlation is determined between the set of movement data points received and/or identified at block 310 and the set of reference points identified and/or received at block 320. For example, the set of movement data points can be associated with respective ones of the reference points. The correlation can be determined automatically and/or determined by a user.

At block 340, one or more control signals are generated to control the robotics device to perform an action and/or change a state based on the desired motion for the robotics device. For example, a control signal can be generated to cause the robotics device to perform a closest approximation of an animated motion, a motion represented in motion capture data, a motion captured using sensor data, and/or a movement of a different robotics device.

The one or more control signals generated at block 340 are generated to change a state of the robotics device. For example, the one or more control signals cause the robotics device to change a position and/or orientation of one or more components, systems, and/or subsystems of the robotics device. In these and other implementations, the state of the robotics device can relate to a position and/or orientation of one or more reference points. The state of the robotics device can relate to a linear movement or an angular movement of at least one component of the robotics device.

The one or more control signals are generated based on the control data for the robotics device and distances between the set of movement data points and respective ones of the reference data points associated with the robotics device. For example, the one or more control signals can be generated to minimize and/or optimize the distances between the movement data points and the reference data points, in view of available control signals for the robotics device.

In some implementations, the one or more control signals are further generated based on one or more weights, such as weights associated with movement data points and/or reference data points. For example, the one or more control signals can be generated to prioritize movements associated with certain movement data points over others.

In some implementations, generating the one or more control signals can comprise determining error values, such as error values associated with distances between movement data points and corresponding reference data points.

In some implementations, determining the control signals can comprise determining a trajectory associated with one or more movement data points.

In some implementations, the process 300 can further include modifying one or more control signals in response to changed environmental conditions. For example, sensor data and/or other data can indicate an unexpected position and/or orientation of one or more components of a robotics device, and the control signals generated at block 340 can be modified and/or adjusted in view of the unexpected position and/or orientation.

In some implementations, a mapping is determined between a target motion for the robotics device and a trajectory for the set of reference points, and a control signal is generated based on the mapping. The mapping can be based on control data and dimensions of the robotics device, and the mapping can be to minimize a distance between the set of reference points and a set of movement data points corresponding to the target motion.

In some implementations, one or more operations of the process 300 can be performed in real time (e.g., in seconds or less) and/or iteratively. For example, the process 300 can be used to generate control signals while a robotics device is performing one or more movements. In these and other examples, the process 300 can be performed over one or more time horizons, which can be short (e.g., 5 seconds, 1 second, less than 1 second) to generate control signals and/or adjust control signals in response to changed environmental conditions (e.g., uneven surfaces, outside forces).

In some implementations, the process 300 includes determining a trajectory associated with at least one movement data point of the set of movement data points, and the control signal is based on the trajectory.

In some implementations, the process 300 includes receiving a set of weights from a user, the weights corresponding to the set of movement data points, and the control signal is determined at least in part based on the set of weights. In these and other implementations, the process 300 can include determining a correlation between a first set of reference points corresponding to one or more locations on the first robotics device a second set of reference points corresponding to one or more locations on a second robotics device, the second robotics device having a second set of characteristics different from the first set of characteristics. And the process 300 can include generating a modified control signal based on the correlation, the second set of characteristics, and the first set of characteristics, the modified control signal to control the second robotics device to generate the desired motion sequence.

The process 300 can include one or more operations performed using the system 105 of FIG. 1, such as operations using equations (1)-(11).

Operations can be added to or removed from the process 300 without deviating from the teachings of the present disclosure. One or more operations of the process 300 can be performed in any order, including performing operations in parallel, and the process 300 or portions thereof can be repeated any number of times.

In an example implementation, the process 300 is used to retarget a target motion between robotics devices of different sizes. For example, the movement data received at block 310 can define a target motion performed by a first robotics device having a first set of proportions that are generally smaller than a second set of proportions of a second robotics device. While the first robotics device and the second robotics device may have different proportions, they may have the same number of legs and otherwise similar components (e.g., head, tail, facial features, etc.). At block 320, data associated with the second robotics device is received. At block 330, a correlation is determined between movement data points for the target motion of the first robotics device and reference data points for the second robotics device. At block 340, a control signal is determined for the second robotics device to retarget the target motion based on the robotics device data for the second robotics device and the correlation determined at block 330. The determined control signal controls the second robotics device to mimic the target motion of the first robotics device while accounting for the characteristics of the second robotics device and ensuring that the operation of the second robotics device remains within an acceptable range.

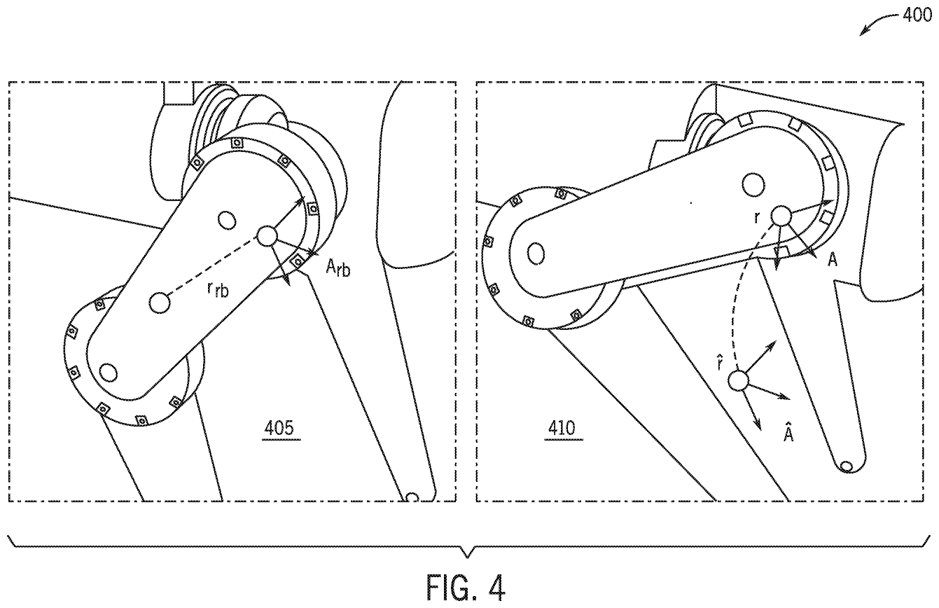

FIG. 4 is a display diagram 400 illustrating operations performed using a robotics device control system.

The display diagram 400 illustrates a first state 405 of at least a portion of a robotics device and a second state 410 of the at least a portion of the robotics device, the first and second states 405, 410 having different positions and/or orientations. For example, the first state 405 can represent a position of the robotics control device before a command is performed and the second state 410 can represent a position of the robotics control device after a command is performed. The states can additionally or alternatively be associated with different velocities, accelerations, forces, and so forth. The first state 405 and the second state 410 can be compared to evaluate and/or determine retargeting objectives according to implementations of the disclosed technology. The retargeting objectives can be based on distances between respective points. In an example implementation, retargeting objectives can be defined for optimizing or minimizing the distance between a target motion and an actual motion of a robotics device.

Given a location r_{rb}, which can be determined and/or input by a user, in the first state 405, and a frame A_{rb}, which can move with a rigid body, the retargeting objective can be determined and/or evaluated by comparing a simulated position r and frame A in the second state 410 to a target position \hat{r} and a target frame Â according to the second state 410. In other words, the target position \hat{r} and the target frame Â indicate a predicted and/or preferred state, whereas the simulated position r and frame A indicate an actual state of a robotics device (e.g., a simulated robotics device) after performing a command.

To evaluate and/or determine state information, orthonormal frame axes can be defined in local coordinates for one or more points of interest (e.g., reference points on a robotics device), such as r_{rb}. The local coordinates can be transformed to global coordinates, as illustrated in equation (4), and one or more frame origins and/or axes represented in that equation can represent parameters that are configured (e.g., optimized) according to the disclosed techniques. For example, retargeting objectives can be determined based on penalizing differences in linear motion between a simulated position r and a target position \hat{r}. Additionally or alternatively, similar objectives can be determined based on angular motion. The differences between actual positions and target positions can be expressed in various ways, such as distances, which can be used to calculate one or more errors and/or to determine appropriate control signals, as described herein.

The disclosed systems and method advantageously allow for target/desired movements to be retargeted for one or more robotics devices, such as different legged robots having different characteristics (e.g., dimensions, mass distributions, degrees of freedom, control systems, appearances, etc.). Additionally, the disclosed systems and methods enable generation of control signals for robotics devices to simulate expressive inputs, such as motion capture inputs, animation inputs, and/or inputs comprising sensor data. Furthermore, the disclosed systems and methods can determine control signals in real time and/or continuously, such as for enabling robotics devices to be adapt to changed environmental conditions. Embodiments allow retargeting of motions onto various robotics devices, which may not be fully actuated, such as freely walking and/or under-actuated robotics devices. Moreover, embodiments allow retargeting of motions onto robotics devices that may have significantly different characteristics (e.g., dimensions, proportions, mass distributions), as compared to the source of the target motion, such as a different robotics device, an actor, or an animal.

The technology described herein can be implemented as logical operations and/or modules in one or more systems. The logical operations can be implemented as a sequence of processor-implemented steps executing in one or more computer systems and as interconnected machine or circuit modules within one or more computer systems. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations can be performed in any order, unless explicitly claimed otherwise or unless a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology can be employed in special-purpose devices independent of a personal computer.

The above specification, examples and data provide a complete description of the structure and use of example embodiments as defined in the claims. Although various example embodiments are described above, other embodiments using different combinations of elements and structures disclosed herein are contemplated, as other implementations can be determined through ordinary skill based upon the teachings of the present disclosure. It is intended that all matter contained in the above description and shown in the accompanying drawings shall be interpreted as illustrative only of particular embodiments and not limiting. Changes in detail or structure can be made without departing from the basic elements as defined in the following claims.

What is claimed is:

1. A computer-implemented method of determining control signals for robotics devices, the method comprising:
receiving movement data corresponding to a desired motion for a robotics device;
receiving robotics device data for the robotics device, wherein the robotics device data includes control data and a set of reference points corresponding to a set of locations on the robotics device;
determining a correlation between a set of movement data points in the movement data and the set of reference points; and
determining, using the control data, at least one control signal to change a state of the robotics device based on the desired motion for the robotics device, wherein the at least one control signal is determined based on a distance between at least one movement data point in the set of movement data points and at least one reference point in the set of reference points.

2. The computer-implemented method of claim 1, wherein the movement data comprises animation data, motion capture data, or sensor data.

3. The computer-implemented method of claim 1, wherein the at least one control signal is determined based on minimizing the distance between the at least one movement data point and the at least one reference point.

4. The computer-implemented method of claim 1, further comprising:
determining a trajectory associated with the at least one movement data point, wherein the at least one control signal is based on the trajectory.

5. The computer-implemented method of claim 1, wherein the set of movement data points, the set of reference points, or both are identified by a user.

6. The computer-implemented method of claim 1, further comprising:
receiving, from a user, a set of weights corresponding to the set of movement data points, wherein the at least one control signal is determined at least in part based on the set of weights.

7. The computer-implemented method of claim 1, wherein the robotics device is a legged robotics device, an under-actuated robotics device, a simulation of a robotics device, or a combination thereof.

8. The computer-implemented method of claim 1, wherein the robotics device data comprises dimensions of the robotics device, mass distribution of the robotics device, a set of possible states of the robotics device, degrees of freedom of at least one component of the robotics device, or combinations thereof.

9. The computer-implemented method of claim 1, further comprising:
modifying the at least one control signal in response to a changed environmental condition.

10. The computer-implemented method of claim 1, wherein determining the at least one control signal comprises determining error values associated with distances between the set of movement data points and the set of reference points.

11. The computer-implemented method of claim 1, wherein the at least one control signal is determined in real time.

12. The computer-implemented method of claim 1, wherein the state of the robotics device comprises a position and an orientation of the at least one reference point at a time point.

13. The computer-implemented method of claim 1, wherein the state of the robotics device relates to a linear movement or an angular movement of at least one component of the robotics device.

14. A computer-implemented method of retargeting of robotics device movements, the method comprising:
receiving movement data corresponding to a target motion for a robotics device;
determining characteristics of the robotics device, wherein the characteristics comprise control data, a set of reference points corresponding to a set of locations on the robotics device, and dimensions of the robotics device;
determining a mapping between the target motion for the robotics device and a trajectory for the set of reference points, wherein the mapping is based on the control data and the dimensions of the robotics device, and wherein the mapping is to minimize a distance between the set of reference points and a set of movement data points corresponding to the target motion; and
generating a control signal based on the mapping.

15. The computer-implemented method of claim 14, wherein the movement data comprises animation data, motion capture data, or sensor data.

16. The computer-implemented method of claim 1, further comprising:
determining a trajectory associated with at least one movement data point of the set of movement data points, wherein the control signal is based on the trajectory.

17. The computer-implemented method of claim 1, wherein the set of movement data points, the set of reference points, or both are identified by a user.

18. The computer-implemented method of claim 1, further comprising:
receiving, from a user, a set of weights corresponding to the set of movement data points, wherein the control signal is determined at least in part based on the set of weights.

19. The computer-implemented method of claim 1, wherein the robotics device is a legged robotics device, an under-actuated robotics device, a simulation of a robotics device, or a combination thereof.

20. At least one computer-readable medium carrying instructions that, when executed by a computing system, cause the computing system to:
receive a desired motion sequence for a first robotics device having a first set of characteristics, wherein the first set of characteristics comprises dimensions of the first robotics device;
determining a correlation between a first set of reference points corresponding to one or more locations on the first robotics device a second set of reference points corresponding to one or more locations on a second robotics device, wherein the second robotics device has a second set of characteristics different from the first set of characteristics; and
generating a modified control signal based on the correlation, the second set of characteristics, and the first set of characteristics, wherein the modified control signal is to control the second robotics device to generate the desired motion sequence.
